(19) United States
(12) Patent Application Publication
(10) Pub. No.: US 2007/0204042 A1
(43) Pub. Date: Aug. 30, 2007

(54) METHOD OF USING A SENDER-SELECTED AUDIO SECURITY FEATURE FOR AUTHENTICATING ACCESS OVER A NETWORK

(75) Inventor: Gayle L. Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/672,379

(22) Filed: Feb. 7, 2007

Related U.S. Application Data
(60) Provisional application No. 60/771,075, filed on Feb. 7, 2006.
(60) Provisional application No. 60/765,991, filed on Feb. 7, 2006.

(51) Int. Cl. G06F 15/173

(52) U.S. Cl. 709/225

(57) ABSTRACT

The present invention include systems, equipment, software, and protocols that enable a sender to select an audible sound, such as an audio security feature or ringtone to be played by a target recipient for the purpose of identifying and/or authenticating the sender, or to enable access to a secured network, or to play a user selected audible sound on a target device. The target recipient can identify the sender by listening to the audible sound, or by analyzing the audible sound with software. This can either allow the target recipient for authenticating access to a controlled area such as a secured network controlled by the target recipient.

### CROSS-REFERENCE TO RELATED APPLICATIONS

This application claims benefit of U.S. Provisional Patent Application Ser. No. 60/771,075 entitled METHOD OF USING A SENDER-SELECTED AUDIO SECURITY FEATURE FOR AUTHENTICATING ACCESS OVER A NETWORK and filed Feb. 7, 2006 and claims the benefit of U.S. Provisional Patent Application Ser. No. 60/765,991 entitled SENDER-SELECTED RINGTONES AND METHODS OF USE and filed Feb. 7, 2006, which applications are incorporated herein by reference in their entirety.

### BACKGROUND OF THE INVENTION

1. The Field of the Invention

The present invention is related to sender-selected audio security features. More particularly, the present invention is related to the use of the sender-selected audio security features for authentication and/or identification of the sender for enabling the sender to gain access over a network. More particularly, the present invention is also related to the use of sender-specific audio-identification during the initiation of a communication in order to notify the recipient of the identity of the sender.

2. The Related Technology

Telecommunications have become an integral aspect of everyday life. People are constantly using phones, such as mobile or landline phones, to contact their family and friends. Often, people want to know who is calling. One way is to identify the caller is for the recipient of the call to review the caller identification display. In addition, some mobile phones are configured to be programmable so as to allow people to program certain ringtones and/or display pictures to be associated with or identify specific callers. While this is useful for allowing the recipient to select a means of identifying the caller, the recipient has to proactively program each specific caller's unique ringtone or display picture into their phone. Also, this does not allow the recipient to identify the caller when the call is being made from a phone other than the caller's personal phone.

While caller identification, receiver-programmable ringtones, and/or display pictures are useful for identifying a specific caller, these means of identification cannot be controlled by the caller. Further, there are instances when a caller would like to be able to select at least one means of caller identification other than the standard numeric caller identification on the recipient's display. Therefore, it would be advantageous for callers to be able to select a means of identifying themselves to the recipient of a telephone call.

This problem also extends to the situations where security is an issue. For example, devices such as mobile phones are increasingly being used to access private data communication networks. As these uses become more prevalent and useful, maintaining the security of, and restricting unauthorized access to, such data communication networks continues to be an important issue. Typically, when attempting to gain access to a data communication network, the security features that conventionally restrict access thereto include logins, passwords, and data encryption. However, hackers have consistently found ways to retrieve these types of information, and use such information in order to compromise the integrity of data communication networks.

Therefore, it would be also be advantageous to have an audio security feature that identifies the entity attempting to gain access to a data communication network including private data communication networks or other secured access area.

### BRIEF DESCRIPTION OF THE DRAWINGS

To describe embodiments, advantages, and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram that illustrates an embodiment of an operating environment for sender-selected audio-identification;

FIG. 2 is a schematic diagram that illustrates an embodiment of a computer system that is operable with the operating environment of FIG. 1;

FIG. 3 is a schematic diagram that illustrates an embodiment of a mobile phone that is operable with the operating environment of FIG. 1;

FIG. 4 is a flow diagram illustrating one embodiment of a protocol for using a sender-selected audio-identification feature;

FIG. 5 is a flow diagram illustrating one embodiment of a protocol for using a sender-selected audio-identification feature;

FIG. 6 is a flow diagram illustrating one embodiment of a protocol for using a sender-selected audio-identification feature;

FIG. 7 is a flow diagram illustrating one embodiment of a protocol for using a sender-selected audio-identification feature;

FIG. 8 is a flow diagram illustrating one embodiment of a protocol for using a sender-selected ringtone identification feature;

FIG. 9 is a flow diagram illustrating one embodiment of a protocol for using a sender-selected ringtone identification feature;

FIG. 10 is a flow diagram illustrating one embodiment of a protocol for using a sender-selected ringtone identification feature; and

FIGS. 11A and 11B are flow diagrams illustrating different embodiments of protocols for accessing a sender-selected ringtone from a ringtone server.

### DETAILED DESCRIPTION OF THE PREFERRED EMBODIMENTS

Generally, embodiments of the present invention include systems, equipment, software, and protocols that enable a sender to select an audible sound to be played by a target recipient for the purpose of identifying the sender and/or to enable access to a secured network. Embodiments of the invention thus relate to systems and methods for using an audio security feature to access a network or to authenticate a caller and to systems and methods for using sender selected audio, such as a sender selected ringtone, that can identify the caller to a recipient.

As such, the target recipient can identify the sender by listening to the audible sound, or by analyzing the audible sound with software and/or hardware. This can either allow the target recipient to authenticate access to a controlled area such as a secured network controlled by the target recipient. In one example, the target recipient can identify the sender by listening to the audible sound. This can either allow the target recipient to decide whether or not to answer a phone call, or be used by the target recipient for authenticating access to a controlled area such as a secured network controlled by the target recipient.

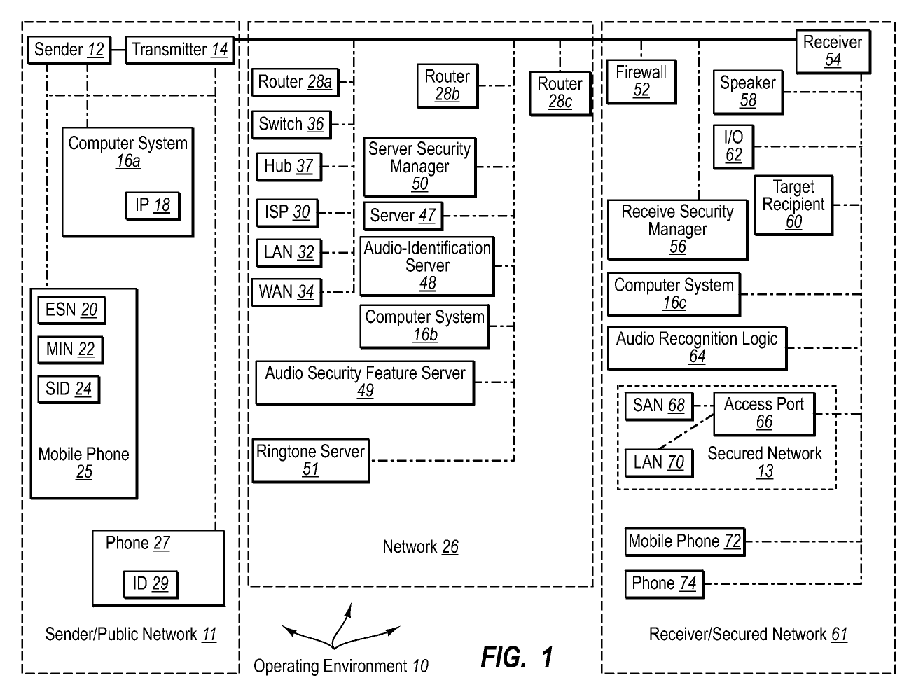

FIG. 1 illustrates an example of an environment for implementing embodiments of the invention. Generally, embodiments of the invention enable a sender 12 to select or provide an audio security feature that can be delivered over a network or any combination of networks to a receiver 54 and/or target recipient 60. The audio security feature can be used, for example, for authentication. Embodiments of the invention further extend to sending sender-selected ringtones to a target device or recipient.

With reference first to FIG. 1, details are provided concerning various aspects of the general architecture of an embodiment of an operating environment 10 in connection with which the systems, methods, software, and/or protocols of the present invention may be practiced. Generally, the operating environment 10 includes a sender 12 that can interface with a transmitter 14. The transmitter 14 can access a network 26 for remote access or communication with a target recipient 60 and/or receiver 54.

The communication network 26 can extend over a long distance, where the sender 12 is positioned at one node within the communication network 26, and the target recipient 60 is positioned at another node. More particularly, the sender can be located within a sending network 11, and the receiver can be located within a receiving network 61. The sending network 11, the network 26 and/or the receiver network 61 can all be part of the same network (a radio frequency cellular network for example), or separate networks of the same or different types.

In one embodiment, the communication network 26 is the Internet, or at least a portion of the communication network 26 can utilize a portion of the Internet as well as electrical, optical, and/or wireless telephone lines. The use of the Internet or telephone lines as a portion of the communication network 26 is convenient because of the availability and prevalence of locations where the Internet and telephone lines can be accessed.

In other cases, the communication network 26 comprises a wide-area network (“WAN”). The use of the Internet or a WAN allows for senders 12 over a broad area to be able to have their transmitter 14 access the communication network 26 and communicate with the receiver 54 and/or target recipient 60. Alternatively, the communication network 26 comprises a local area network (“LAN”) or an intranet. The use of a LAN or intranet as part of the communication network 26 can include safety features, such as firewalls 52 or receiver security managers 56, for example, to prevent unauthorized access from outside of secured locations. As such, a LAN or intranet can be used so that the sender 12 and/or transmitter 14 communicate with a receiver 54 and/or target recipient 60 that is within a secured area.

Accordingly, embodiments of the invention are suitable for use in conjunction with various high speed data transmission systems, examples of which include Gigabit Ethernet (“GE”), 10 GigE, Fiber Distributed Data Interface (“FDDI”), Fibre Channel (“FC”), Synchronous Optical Network (“SONET”), InfiBand, and other similar protocols. Configuring the transmitter 14 and/or the receiver 54 to communicate with equipment conforming to the Gigabit Ethernet (“GigE”) physical specification is only an example, and embodiments of the invention may, more generally, be employed in any of a variety of these and other high speed data transmission systems, some of which may have line rates up to, or exceeding, 10 Gb/s.

Some embodiments of the present invention are implemented in connection with a secure operating environment such as the receiver network 61. In the secure operating environment, a transmitter 14 communicates with the remote receiver 54 through a public communication network 11 (sender network) and a secured data communication network 61. The public data communication network 11 can include a public data communication link for propagating data between the transmitter 14 and the secured data communication network 61. Additionally, the public data communication network 11 and/or the secure data communication network 61 can include the Internet, WAN, LAN, and/or intranet as well as electrical, optical, and/or wireless telephone lines.

With continuing reference to FIG. 1, a general embodiment of an operating environment 10 is depicted in accordance with the present invention. Such an operating environment 10 includes a sender 12 that is attempting to communicate with a target recipient 60. Accordingly, the sender 12 can utilize a transmitter 14 in order to initiate and propagate any type of communication, such as a data or voice communication, across a network 26 in order to be received by the target recipient 60. The target recipient 60 can utilize a receiver 54 to receive the incoming transmission from the transmitter 14. Also, the receiver 54 can include a security manager 56 so that only authorized data transmissions are enabled and connected with the receiver 54.

In one embodiment, the sender 12 interfaces with a computer system 16a, which can provide any type of data to the transmitter 14. As such, the data provided from the computer system 16a can then be transmitted by the transmitter 14 over the network 26. The computer system 16a is described in greater detail below.

Additionally, in order to communicate over the network 26, the sender 12 can have and/or present a unique identifying number such as an IP address 18 or similar identification. The IP address 18 can be supplied by the transmitter 14 for enabling or authorizing access to the network 26. As such, the network 26 can include an internet service provider (“ISP”) 30 that regulates or enables the network transmissions or communications. The sender 12 can access the network 26 by connecting with the ISP 30 and supplying the IP address 18 or other unique identification. This allows the sender 12 and/or transmitter 14 to be connected with, and/or become part of, the network 26.

The network 26 can include routers 28a-c, switches 36, and/or hubs 37. The routers 28a-c, switches 36, and/or hubs 37 can determine where to send the information or data that has been input into the transmitter 14 or computer system 16a by the sender 12. Accordingly, the routers 28a-c, switches 36, and/or hubs 37 can operate to ensure that the data transmitted by the transmitter 14 goes to the target recipient 60 or server 47 rather than an unintended recipient. More particularly, the routers 28a-c, switches 36, and/or hubs 37 can direct the data communication from the transmitter 14 first to the server 47 and then to the receiver 54. Thus, the routers 28a-c, switches 36, and or hubs 37 can aid in correctly passing information through the network 26 to its target recipient 60.

Additionally, the network 26 can include, and/or have access to, a wide variety of servers 47. However, before gaining access to any of the servers 47, the data transmission may have to pass through a server security manager 50. As such, the server security manager 50 can require a login, password, and/or any type of encrypted data or security key in order to gain access to the servers 47. Additionally, any of the servers 47 can include, or be associated with, a computer system 16b. Such a computer system 16b can be substantially similar with any known computer system, and will be described in further detail below.

One embodiment of a server 47 in accordance with the present invention is an audio-identification server 48. The audio-identification server 48 provides an audio-identification service so as to retain, store, and/or distribute audio-identification clips or files. Such an audio-identification clip can be an audio data file that is encoded in a manner so as to cause an audible sound to be played over a speaker 58 or through audio recognition logic 64. The audio data file can be any audible sound or series of sounds that can identify the sender 12 to the target recipient 60. An example of an audio-identification clip can be the voice of the sender, a certain song, or other audible noise that can be used to identify the sender 12.

Additionally, the sender 12 can have a plurality of audio-identification clips stored on the audio-identification server 48, which can be accessed and/or transmitted to the target recipient 60. Also, the sender 12 can have specific audio-identification clips for different target recipients 60. As such, the sender 12 can access the audio-identification server 48, and select a specific audio-identification clip to be sent to the target recipient 60. More particularly, the sender 12 can use the transmitter 14 and/or computer system 16a to access the audio-identification server 48 in order to store, save, or otherwise utilize any audio-identification clip stored thereon.

In another embodiment, the server 47 can be an audio security feature server 49. An audio security feature server 49 can be similar with any known type of server, so as to be capable of receiving, storing, and/or transmitting an audio security feature to the target recipient 60. More specifically, the sender 12 can utilize a transmitter 14 and/or computer system 16a in order to access the audio security feature server 49, and select an audio security feature for transmission to the receiver 54. Similar to the audio-identification clip, an audio security feature can be any audible sound file.

While the audio security feature can be similar to an audio-identification clip, the security feature aspect denotes that the audio security feature serves to authenticate secured access into remote facilities, such as those accessible through the receiver 54. Accordingly, the audio security feature can be implemented in a security protocol which requires authentication of the audio security feature before access, connection, and/or data transmission through or with the receiver 54 can be enabled. While many types of security features are well known, the current invention utilizes an audio clip as a security feature. By using an audio clip as a security feature, the receiver 54 can play the audio clip so that the target recipient 60 can listen to the audio security feature in order to determine whether or not access into the receiver network can be enabled for the sender 12.

In one embodiment, the receiver 54 can pass the audio security feature to audio recognition logic 64 for processing. Such audio recognition logic 64 can be utilized via a computer system 16c, wherein such a computer system 16c is described in more detail below. In any event, when the receiver 54 receives the audio security feature from the audio security feature server 49, the audio recognition logic 64 can be configured to monitor the data contained in the audio security feature and compare that data to authorized or unauthorized audio security features. If the audio recognition logic 64 identifies, accepts, and/or recognizes the audio security feature, access to, or connection with, the receiver 54 can be enabled. On the other hand, if the audio recognition logic 64 does not recognize the audio security feature or recognizes the audio security feature to be unauthorized, access to, or through, the receiver 54 can be denied.

In one embodiment, the receiver 54 can play the audio security feature over a speaker 58 so that the target recipient 60 can listen to an audible clip of the audio security feature. As such, the target recipient can listen to the sound(s) in order to make a determination of whether access to, or through, the receiver 54 will be allowed or denied. The target recipient 60 can utilize any input or output device 62 so as to communicate the determination of whether access will be allowed or denied to the receiver 54.

In one embodiment, the audio security feature can be utilized when the sender 12 is trying to access or communicate with an access port 66 controlled or within a receiver network 61 of the target recipient 60. More specifically, the access port 66 can provide for access into a secured network 13. The access port 66 can be considered to include gateways to critical information stored in the secured network 13, such as in a storage area network (“SAN”) 68 or a local area network (“LAN”) 70. Accordingly, the access port 66 can allow access into the SAN 68 and/or LAN 70. In this manner, the audio security feature obtained from the audio security feature server 49 can be utilized, optionally along with other security protocols, in order to enable access into such an access port 66. Additionally, a login, password, and/or other encrypted data or security key may be required along with the audio security feature in order to access the access port 66 or enable communication with, or through, the access port 66.

In one embodiment, the sender 12 may attempt to gain access to the access port 66 or communicate therewith so as to acquire data from the receiver SAN 68, supply data thereto, and/or implement a diagnostic network function. In the alternative, the sender 12 may attempt to gain access to the receiver LAN 70 for any of the various well-known networking functions, which can include a diagnostic network function. One such diagnostic networking function may include monitoring and/or analyzing the operation of the SAN 68 and/or LAN 70. Thus, the sender 12 may be capable of remotely monitoring and/or analyzing a SAN 68 and/or LAN 70 by providing an audio security feature as, or part of, a security protocol. In this manner, the target recipient 60 can authenticate the audio security feature to ensure only proper and authorized entities (sender 12) can access or communication through the access ports 66.

In one embodiment, a sender 12 may utilize a transmitter 14 that is configured to be, or is used in conjunction with, a transmitting mobile phone 25. Also, the target recipient 60 can utilize a receiver 54 that is configured to be, or is used in conjunction with, a receiving mobile phone 72. As such, the network 26 can include any of the well-known cellular or PCS-type mobile phone communication networks that have the equipment, systems, and/or protocols required for mobile telecommunications. Also, any mobile phone communication network can be used.

In one embodiment, the transmitting mobile phone 25 may need to supply the network 26 with an electronic serial number (“ESN”) 20, which is a unique serial number (e.g. 32-bit phone identification number) programmed into the transmitting mobile phone 25 at, or post, manufacture. An ESN 20, which can be used as a security key, may be required in order for the transmitting mobile phone 25 to access the communication network 26 and/or any of the servers 47 described in connection therewith. Also, the ESN 20 may be needed for any communication with the receiver 54, or to enable communication between the sender 12 and target recipient 60.

Similarly, the transmitting mobile phone 25 may need to provide a mobile identification number (“MIN”) 22 to the network 26. Such an MIN 22 is usually a 10 digit number that is derived from the mobile phone number such as the telephone number that is dialed in order to gain access and communicate with the transmitting mobile phone 25. On the other hand, the MIN 22 can be some other identifying number or security key. In any event, an MIN 22 can be used during authentication or identification of the sender in order to gain access to any of the servers 47 through the server security manager 50 or to the receiver 54 through the receiver security manager 56. Optionally, a combination of an ESN 20 and an MIN 22 can be utilized along with the sender-selected audio-identification for such security protocols or enabling secured access to a secured network 13.

In another embodiment, the transmitting mobile phone 25 may need to retain and supply a system identification code (“SID”) 24 to the network 26, server security manager 50, and/or receiver security manager 56. The SID 24 can be a unique number (e.g. 5-digit number) that is assigned to each mobile line carrier by the FCC. A combination of the ESN 20, MIN 22, and SID 24 can be utilized along with the sender-selected audio->identification in order to gain access into the network 26, the servers 47 through the server security manager 50, and/or the target recipient 60 through the receiver security manager 56. Accordingly, by using transmitting mobile phone 25 identifiers, such as the ESN 20, MIN 22, and SID 24, and optionally, any other personal identification number (“PIN”), the sender 12, through the transmitting mobile phone 25, can gain access into any of the servers 47 such as the audio-identification server 48, computer system 16b, or an additional ringtone server 51.

The ringtone server 51 is one embodiment of a server 47 that is dedicated to receiving, storing, and/or transmitting ringtones. The ringtones can be specific to the sender 12 or accessed by the sender 12. This enables the sender 12 to be capable of accessing the ringtone server 51, and either automatically selecting a ringtone to be sent to the target recipient 60, or browse through various ringtones stored thereon. The sender 12 can then select a ringtone to be sent to the target recipient 60 during a specific and/or current communication, or select and identify a certain ringtone to be sent from the sender 12 to the target recipient any time a communication is originated by the sender 12 to be received by the target recipient 60.

In operation, the sender 12 can dial-up the number associated with the receiving mobile phone 72 of the target recipient 60. As such, the sender 12 instructs the transmitting mobile phone 25 to use any of the various foregoing identification numbers, which can include the telephone number assigned to the transmitting mobile phone 25, to be sent to the receiving mobile phone 72 of the target recipient 60. When the receiving mobile phone 72 receives the transmission from the transmitting mobile phone 25, instead of playing a generic ringtone or ringtone programmed by the target recipient, the receiving mobile phone 72 will instead play the ringtone selected by the sender 12.

Accordingly, various ringtone transfer options can enable this transaction. One such transfer option can include the sender 12, through the transmitting mobile phone 25, requesting the ringtone server 51 to transmit the selected ringtone to the receiving mobile phone 72. Alternatively, the transmitting mobile phone 25 can determine whether or not the receiving mobile phone 72 accepts such sender-selected ringtones, which can be obtained from the ringtone server 51. If the receiving mobile phone 72 is ringtone enabled, the receiving mobile phone 72 can access the ringtone server 51 by supplying any of the various identification numbers or combinations thereof provided by the transmitting mobile phone 25. This can instruct the ringtone server 51 to transmit and/or otherwise download the specific ringtone selected by the sender 12 to the receiving mobile phone 72. Thus, this feature can enable the sender 12 to send a sender-selected or sender-specific ringtone to the receiving mobile phone 72 of the target recipient for specialized and/or personal identification of the sender 12 to the target recipient 60.

In another embodiment, sender 12 may utilize a standard or typical transmitting landline phone 27 in order to communicate with the target recipient 60. Accordingly, the target recipient 60 can receive an ordinary telephone call on a receiving landline phone 74 or a receiving mobile phone 72. In any event, sender 12 can utilize a transmitting landline phone 27 that has an identification number 28 associated therewith, such as the telephone number, to identify the sender 12 or transmitting landline phone 27 by numeric identification 29. Additionally, the numeric identification 29 can be used in conjunction with a sender-selected ringtone.

In one embodiment, the sender 12 can utilize the transmitting landline phone 27 and the associated numeric identification 29 as well as any other identification or personal identification number to be able to access any of the servers 47 on the network 26, such as the ringtone server 51, to cause the receiving mobile phone 72 or the receiving landline phone 74 to ring with the sender-selected ringtone.

General embodiments of an operating environment 10 in accordance with the present invention have now been described. It should be recognized that various modifications can be made, and still retain the general concept of a sender 12 using a network 26 to communicate with a target recipient 60, wherein the identity of the sender 12 is provided by an audio-identification, audio security feature, and/or a ringtone that has been selected by the sender 12. Thus, modifications or changes to such operating environments can be made within the scope the present invention, and only general operating environments have been described as examples of how the use of a sender-selected audio security feature or sender-selected ringtone can identify the sender 12 to any target recipient 60.

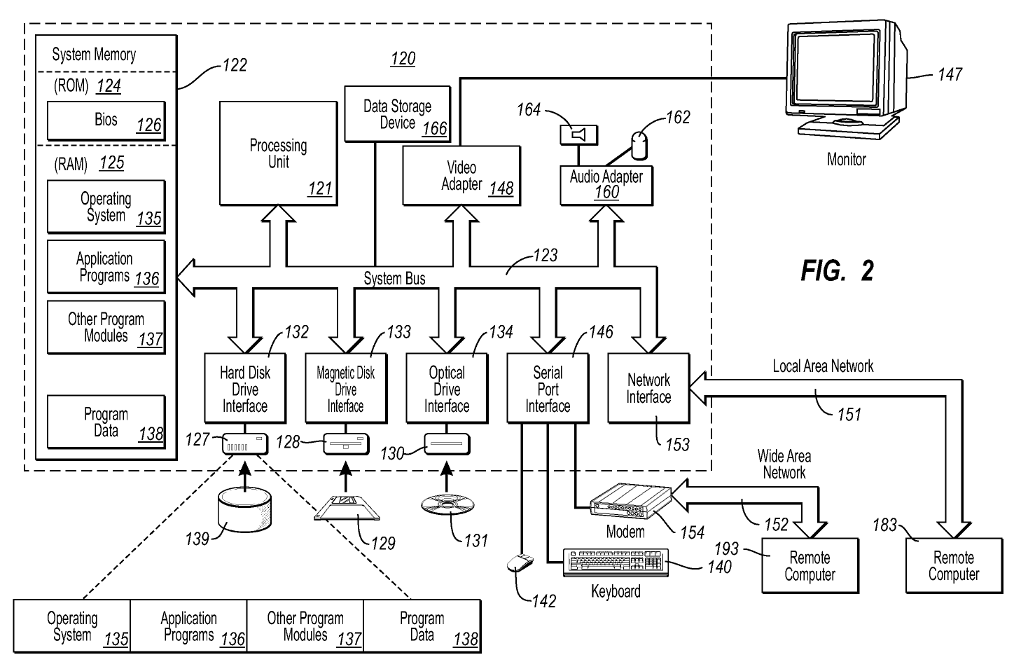

FIG. 2 and the following discussion are intended to provide a brief, general description of a suitable computing environment in which the invention may be implemented. Although not required, the invention can be implemented in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference now to FIG. 2, an example of a general-purpose computer system 120 for implementing the invention is depicted. Such a general-purpose computer system 120 can include a processing unit 121, a system memory 122, and a system bus 123 that couples various system components including the system memory 122 to the processing unit 121. Processing unit 121 can execute computer-executable instructions designed to implement features of computer system 120, including features of the present invention. The system bus 123 may be any of several types of bus structures including a memory bus or memory controller, a peripheral bus, and a local bus using any of a variety of bus architectures. The system memory includes read only memory (“ROM”) 124 and random access memory (“RAM”) 125; however, other types of memory can be used such as EPROM, EEPROM, and the like. A basic input/output system (“BIOS”) 126, containing the basic routines that help transfer information between elements within computer system 120, such as during start-up, may be stored in ROM 124.

The computer system 120 may also include magnetic hard disk drive 127 for reading from and writing to magnetic hard disk 139, magnetic disk drive 128 for reading from or writing to removable magnetic disk 129, and optical disk drive 130 for reading from or writing to removable optical disk 131, such as, or example, a CD-ROM, DVD-ROM, or other optical media including magneto-optical media. Also, the computer system 120 includes a generic data storage device 166, which can be any type of data storage device. In any event, the magnetic hard disk drive 127, magnetic disk drive 128, optical disk drive 130, and/or generic data storage device 166 are connected to the system bus 123 by hard disk drive interface 432, magnetic disk drive-interface 433, optical drive interface 434, and generic data storage device interface 167, respectively. The drives and their associated computer-readable media provide nonvolatile storage of computer-executable instructions, data structures, program modules, and other data for the computer system 120. Although the example environment described herein employs a magnetic hard disk 139, removable magnetic disk 129, removable optical disk 431, and generic data storage device 166, other types of computer readable media for storing data can be used, including magnetic cassettes, flash memory cards, digital versatile disks, Bernoulli cartridges, RAMs, ROMs, and the like.

Program code means components comprising one or more program modules may be stored on hard disk 139, magnetic disk 129, optical disk 131, ROM 124, RAM 125, and/or generic data storage device 166, including an operating system 135, one or more application programs 136, other program modules 137, and program data 138. A user may enter commands and information into computer system 120 through keyboard 140, pointing device 142, or other input devices (not shown), such as, for example, a microphone 162, joy stick, game pad, scanner, or the like. These and other input devices can be connected to the processing unit 121 through input/output interface 146 or audio adapter 160 coupled to system bus 123. Input/output interface 146 logically represents any of a wide variety of different interfaces, such as, for example, a serial port interface, a PS/2 interface, a parallel port interface, a Universal Serial Bus (“USB”) interface, or an Institute of Electrical and Electronics Engineers (“IEEE”) 1394 interface (i.e., a FireWire interface), or may even logically represent a combination of different interfaces.

A monitor 147 or other display device is also connected to system bus 123 via video interface 148. Speakers 164 or other audio output devices are also connected to system bus 123 via the audio interface 160. Other peripheral output devices (not shown), such as, for example, printers, can also be connected to computer system 120.

Computer system 120 is connectable to computer networks, such as, for example, an office-wide or enterprise-wide computer network, a home network, an intranet, the Internet, WAN, LAN, SAN, wireless network, and the like. Accordingly, the computer system 120 can be any type of computer, computing device, electronic communication device, or other similar workstation that can interface with a remote computer such as the receiver 54 or audio-identification server 48, audio security feature server 49, or ringtone server 51 with respect to FIG. 1. Also, computer system 120 can exchange data with external sources, such as, for example, remote computer systems, remote applications, remote servers, remote security managers, and/or remote databases over such computer networks.

Computer system 120 includes network interface 153, through which computer system 120 receives data from external sources and/or transmits data to external sources. As depicted in FIG. 2, network interface 153 facilitates the exchange of data with a remote computer system 183 such as various servers or receivers via link 151. Network interface 153 can logically represent one or more software and/or hardware modules, such as, for example, a network interface card and corresponding Network Driver Interface Specification (“NDIS”) stack. Link 151 represents a portion of a computer network (e.g., an Ethernet segment), and remote computer system 183 represents a node of the computer network that stores and manages application data or any type of data communication.

Likewise, computer system 120 includes input/output interface 146, through which computer system 120 receives data from external sources and/or transmits data to external sources. Input/output interface 146 is coupled to modem 154 (e.g., a standard modem, a cable modem, or digital subscriber line (“DSL”) modem), through which computer system 120 receives data from and/or transmits data to external sources. As depicted in FIG. 2, input/output interface 146 and modem 154 facilitate the exchange of data with remote computer system 193 via link 152. Link 152 represents a portion of a computer network and remote computer system 193 represents a node of the computer network.

In accordance with the present invention, database applications, message applications, and user-interfaces as well as associated data, including application data, schemas, message items, content, attachments, message silos, document silos, audio security features, ringtones, and queries may be stored and accessed from any of the computer-readable media associated with computer system 120. For example, portions of such modules and portions of associated program data may be included in operating system 135, application programs 136, program modules 137 and/or program data 138, for storage in system memory 122.

When a mass storage device, such as, for example, magnetic hard disk 139, is coupled to computer system 120, such modules and associated program data may also be stored in the mass storage device. In a computer network environment, program modules depicted relative to computer system 120, or portions thereof, can be stored in remote memory storage devices, such as, system memory and/or mass storage devices associated with remote computer system 183 and/or remote computer system 193. Execution of such modules may be performed in a distributed environment as previously described.

Additionally, the computer system 120 can store audio-identification files, audio security feature files, and/or ringtone files in any of the data storage devices. Also, the computer system can store and/or execute computer-executable instructions that facilitate the use and/or transmission of the audio-identification files, audio security feature files, and/or ringtone files. Moreover, the computer system, 120 can store and/or implement various protocols that enable the sender to select an audio-identification file, audio security feature file, and/or ringtone file for notifying a target recipient of the sender's identification. Thus, the computer system 120 can be used for implementing or executing any of the sender-selected audio-identification files, programs, and/or protocols described herein.

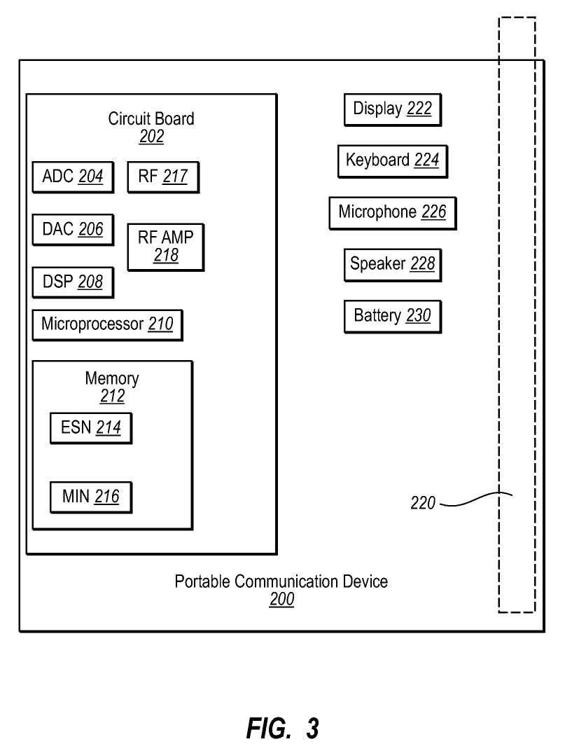

With reference now to FIG. 3, a schematic diagram depicts an example of an embodiment of a portable communication device 200. Such a portable communication device 200 can be used in conjunction with, or in substitution of, the transmitter 14, transmitting mobile phone 25, receiver 54, and/or receiving mobile phone 72 of FIG. 1, as well as the computing system of FIG. 2. Examples of portable communication devices 200 include mobile phones, pagers, PDAs equipped with portable communication technology, and the like.

The portable communication device 200 can include a circuit board 202 that has various hardware and software to enable operation thereof. As such, the circuit board 202 can include an analog-to-digital converter 204 and a digital-to-analog converter 206. The analog-to-digital converter 204 can include conversion chips that translate an audio signal from analog to digital, and and/or the digital-to-analog converter 206 can include conversion chips that translate an audio signal from digital to analog.

Additionally, the circuit board 202 can include a digital signal processor (“DSP”) 208. The DSP 208 can be a typical or highly customized processor that is designed to perform signal manipulation calculations at high speed. This can enable the portable communication device 200 to communicate with remote towers or other signal sending and/or acquiring structures so as to be capable of communicating therebetween. Also, this enables the portable communication device 200 to be mobile so as to move about freely and still retain communication with a network and/or other mobile communication devices or landline communication devices.

The circuit board 202 can also include a microprocessor 210 that is configured to handle the housekeeping chores for the other components on the portable communication device 200. The microprocessor 210 can command and control any signal communication with a base station in communication with the portable communication device 200, and coordinate the rest of the functions on the circuit board 202. Also, the microprocessor can implement the sender-selected ringtone protocols described herein.

Additionally, the circuit board 202 can include memory 212. The memory 212 can be any type of memory such as, but not limited to, read-only memory (“ROM”), flash memory chips, and the like. Accordingly, the memory 212 can be considered to be a generic data storage device. Such memory 212 can provide storage for an operating system for the portable communication device 200 and sender-selected ringtone programs, and the like. Also, the memory 212 can store at least one, or probably a plurality, of sender-selected ringtones or ringtone keys so that they can be browsed and selected by the user and sent to a recipient. Additionally, the memory 212 can include the ESN 214, MIN 216 or other identification number, which can be used in any of the various security protocols described herein.

Additionally, the circuit board 202 can include radio frequency (“RF”) assemblies 217, RF amplifiers 218, and an antenna 200. Such RF assemblies 217 and RF amplifiers 218 can utilize radio frequency in order to be able to communicate with the base station utilizing the antennae 220. In any event, the portable communication device 200 is configured to be able to remotely communicate with a base station to enable data communications to be transmitted to and from the base station and the portable communication device 200. This also allows the portable communication device 200 to communicate data to and from a target recipient such as the target recipient 60 of FIG. 1.

In one embodiment, user interfaces are included that are common on many portable communication devices 200. An example of a user interface is a display 222 that allows a user, such as a sender 12 of FIG. 1, to be able to read any information displayed on the display 222. Also, the portable communication device 200 can include a keyboard 224 that enables the user to input data or other information into the portable communication device 200 such as the telephone number of a landline or mobile phone. Moreover, the keyboard 224 can be utilized to input security codes, other security information or select a ringtone. This allows the security codes, other security information, or selected ringtone to be transferred to any of the various servers and/or receiving devices of the target recipient.

Additionally, another user interface included with the portable communication device is a microphone 226. A microphone 226 is included so that the user can verbally or audibly input data to be sent or transmitted therefrom. Correspondingly, the portable communication device 200 can include at least a speaker 228 so that any audible data that is transmitted thereto can be audibly played. The audible data can include a conversation, ringtones, such as sender-selected ringtones, or any other data.

Additionally, in order to be portable, the portable communication device 200 includes a battery 230. As such, the battery 230 can be any lithium ion, nickel cadmium, or any battery that is well known in the art.

In one embodiment, the sender-selected ringtone to be played on the target recipient's landline or mobile phone can be described as a computer-readable program that is downloaded or stored on the receiving memory chip 212 in the receiving phone. The ringtone program instructs the microprocessor 210 of the phone what the speaker 228 on the receiving device will play when it receives an incoming call. A ringtone compatible phone can have a range of notes stored in memory 212, which includes information on speaker vibration frequencies that will produce particular tones.

The ringtone program instructs the microprocessor 210 which notes to play, as well as the order and speed the notes should be played. Accordingly, by adjusting these variables, the microprocessor 210 can play an almost infinite number of ringtone sequences, which allows the sender to select which ringtone to play. For example, the ringtone can be programmed to instruct the speakers to play any specific note for the duration of a full note, half note, quarter note, eight note, sixteenth note, or thirty second note as well as in what octave the note resides. Also, the ringtone program can include the tempo and beats per minute. By being a ringtone program, the ringtone itself can be transmitted from a transmitter and/or ringtone server to the phone of the target recipient.

Additionally, the ringtone program can be a sender-selected ringtone program that can operate on a transmitting and/or receiving portable communication device. When on a transmitting device, the sender-selected ringtone program can enable the sender to select the ringtone to be played on the receiving device. On the other hand, when on a receiving device, the ringtone program can enable the sender-selected ringtone to be played thereon to notify the receiver of the sender's identity.

While FIGS. 1-3 represent some suitable operating environments and equipment for the present invention. The principles of the present invention may be employed in any system that is capable of, with suitable modification if necessary, implementing the principles of the present invention. Accordingly, the environments illustrated in FIGS. 1-3 are illustrative only and by no means represents even a small portion of the wide variety of environments in which the principles of the present invention may be implemented. Additionally, many of the features described in FIGS. 1-3 can be combined so as to be capable of operating together.

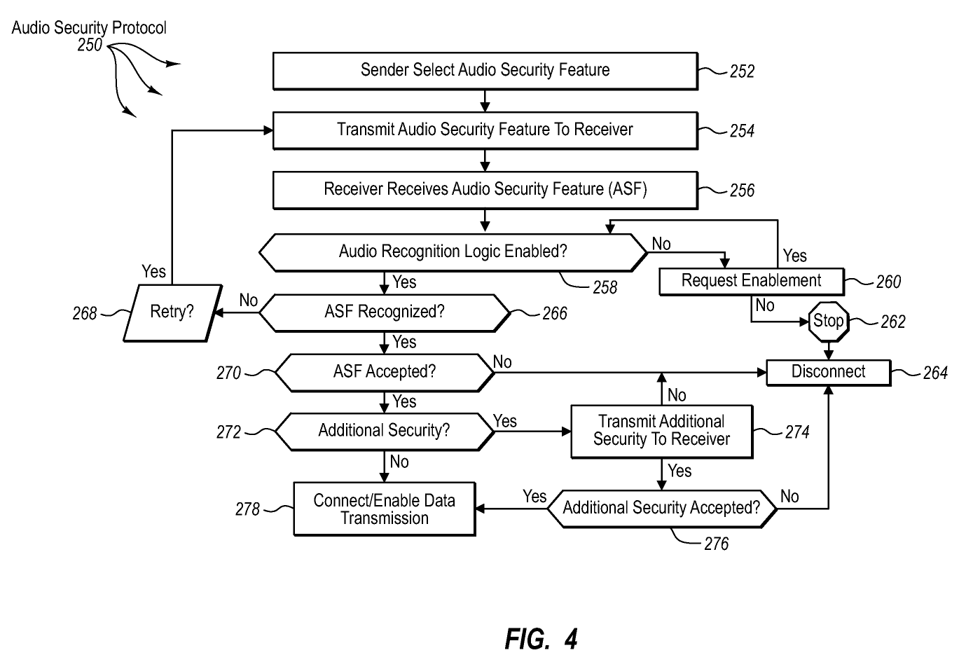

Referring now to FIG. 4, which is a flow diagram illustrating an embodiment of an audio security protocol 250 in accordance with the present invention. Such an audio security protocol 250 is intended to be operable within the operating environment 10 of FIG. 1, and can utilize any of the associated equipment and devices as described in FIGS. 1-3. Accordingly, the audio security protocol 250 includes a process wherein a sender utilizes a transmitter to transmit identification to a target recipient, and the target recipient utilizes a receiver to receive such incoming data or communication from the sender. Additionally, the audio security protocol 250 can include transmissions that utilize a server, such as an audio-identification server, associated computer system, and/or an audio security feature server.

In order to operate under the audio security protocol 250, the sender selects an audio security feature (“ASF”) to identify themselves to the receiver at 252. As such, the sender can browse through any number of predetermined audio security features, or identify a new audio security feature for identification. After selecting the audio security feature, the sender can instruct an associated transmitter to send the audio security feature to the receiver of the target recipient. Thus, the sender-selected audio security feature selection is input into the transmitter, and the transmitter then transmits the audio security feature to the receiver. This transmission can be conducted over any communication network. Further, it may be the server that transmits the audio security feature rather than a transmitter of the sender.

After being transmitted, the receiver receives the sender-selected audio security feature at 256. In order to assess the authenticity of the audio security feature, the receiver and/or any associated computer system can determine whether any audio recognition logic is enabled at 258. Such audio recognition logic is typically in the form of an algorithm that can assess, analyze, and/or monitor the audio security feature for authentication. Alternatively, the audio recognition logic can match the audio security feature with authorized or unauthorized audio files, where a match can grant access or authorization to the sender in order to enter into the access port and/or secured network associated with the receiver.

In the instance it is determined that the audio recognition logic is not enabled, a request for enablement can be made at 260. Accordingly, when the request for enablement is made, the receiver and/or associated computer system can again assess whether or not the audio recognition logic is enabled at 258. However, the request for audio recognition logic enablement may be denied at 260, and the audio security protocol can be terminated or stopped at 262. When the audio security protocol is terminated or stopped, the communication between the transmitter and receiver can be disconnected at 264.

In the instance the audio recognition logic is enabled, the receiver and/or any associated computer system can utilize the audio recognition logic to compare the audio security feature with authorized audio files, or determine whether or not the audio security feature is recognized at 266. In one option, the audio recognition logic can determine that the audio security feature is not recognized at 266. When the audio security feature is not recognized, a retry can be initiated at 268. Such a retry can notify the transmitter to retransmit the audio security feature to the receiver and continue through the audio security protocol at 254.

In another option, the audio recognition logic can determine that the audio security feature is recognized at 266. When the audio security feature is recognized, a determination can be made as to whether or not the audio security feature is acceptable at 270. The determination of acceptance can be made by matching the audio security feature with audio files to which access has been granted, or authorization to access the receiver as well as any computer system, access port, or secured network associated therewith. Non-acceptance of the audio security feature can result in the audio security protocol 250 immediately disconnecting or terminating any communication between the transmitter and the receiver at 264.

In the instance the audio security feature is accepted, the audio security protocol 250 can determine whether or not any additional security profile needs to be assessed at 272. Such an additional security profile can be in the form of logins, passwords, encryption, and/or other security codes or security keys required for authentication. When an additional security profile is required, a request can be sent to the transmitter to transmit the additional security to the receiver at 274. The non-transmission of the requested additional security profile to the receiver at 274 can result in the audio security protocol 250 disconnecting the communication between the transmitter and the receiver at 264. Alternatively, transmission of the requested additional security profile to the receiver can result in an analysis of whether or not the additional security profile is acceptable at 276.

Analyzing the acceptability of the additional security profile can be performed by being processed through an algorithm in order to check the submitted additional security profile against acceptable and unacceptable security profiles. The submission of an unacceptable security profile can result in the communication between the transmitter and receiver being disconnected at 264. However, acceptance of the additional security profile can connect the communication between the transmitter and receiver so as to enable data transmission there between at 278.

In another embodiment, a determination that the additional security profile is not necessary can result in the communication between the transmitter and receiver being connected so as to enable data transmission therebetween at 278. As such, when the connection is made between the transmission and receiver so as to enable data transmission, the audio security feature has been successfully utilized as a means for having an audible aspect of authenticating access to a secured area.

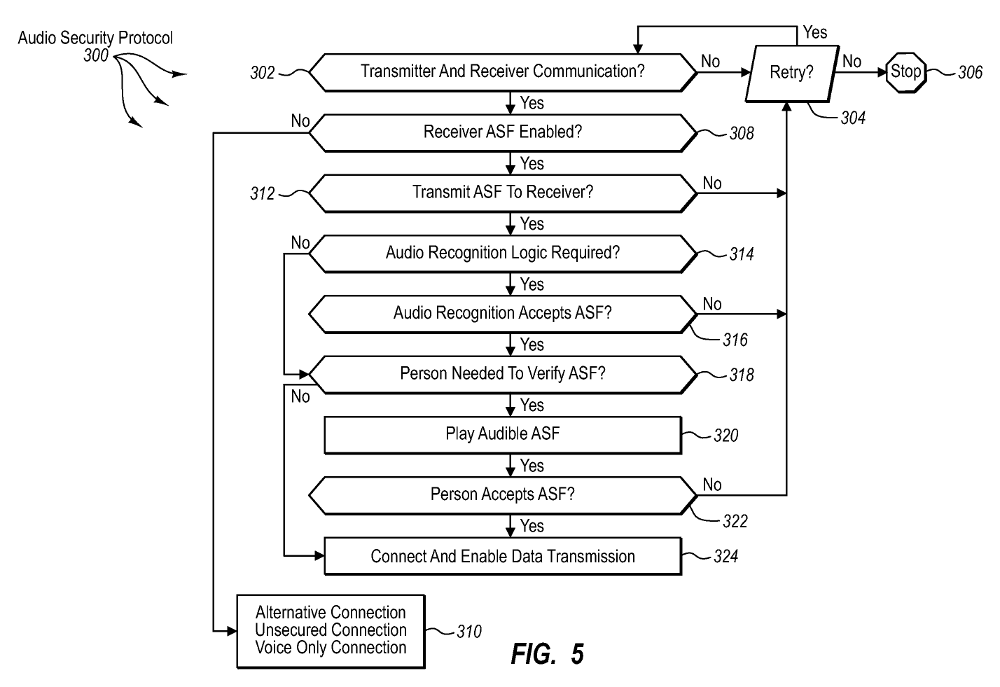

Referring now to FIG. 5, which is a flow diagram illustrating one embodiment of an audio security protocol 300 in accordance with the present invention. Such an audio security protocol 300 is initiated by making a determination as to whether or not the transmitter and receiver are in communication at 302. If it is determined that the transmitter and receiver are not in communication, a retry sequence can be initiated at 304. Initiation of a retry sequence can result in another determination as to the presence of transmitter and receiver communication. On the other hand, if the retry sequence is denied, the audio security protocol 300 can stop at 306.

In the instance the transmitter and receiver are in communication, a determination can be made as to whether or not receiver audio security feature acquisition and/or processing mechanisms (algorithms) are present or have been enabled at 308. Non-enablement or non-presence of the receiver audio security feature acquisition and/or processing mechanism can result in an alternative connection, unsecured connection, or a voice-only connection being made at 310. Such connections that do not require authentication of the audio security feature may inhibit or prevent any transmission of secured data between the transmitter and receiver. As such, this essentially terminates the audio security protocol 300.

The enablement of the receiver audio security feature acquisition and/or processing mechanisms can result in the audio security feature being transmitted to the receiver at 312. Any non-transmission of the audio security feature to the receiver can result in another retry sequence at 304. On the other hand, the transmission of the audio security feature to the receiver and the reception thereof can lead to an assessment as to whether or not any audio recognition logic processing of the audio security feature is required at 314.

In the instance the audio recognition logic is required to process the audio security feature; such audio recognition logic can be used to make a determination as to whether or not the audio security feature is acceptable or not at 316. An unacceptable audio security feature can cause another retry sequence to be initiated at 304. On the other hand, an acceptable audio security feature can allow the audio security protocol 300 to be continued. Alternatively, when the audio recognition logic is not required at 314, the audio security protocol 300 can then continue without processing the audio security feature through the audio recognition logic.

Accordingly, continuation of the audio security protocol results in a determination as to whether or not a person is needed to verify the audio security feature at 318. The requirement of a person verifying the audio security feature can result in the receiver or other associated computer system playing the audible audio security feature in a manner that can be heard by the person at 320. As such, the person can determine whether or not to accept the audio security feature at 322. An unacceptable audio security feature can initiate another retry sequence at 304. On the other hand, an acceptable audio security feature can connect the transmitter and receiver in a manner so as to enable data transmission therebetween at 324.

Alternatively, in the instance that no person is needed to verify the audio security feature, the audio security protocol 300 can then move directly to connecting the transmission between the transmitter and receiver so as to enable the data transmission at 324. Additionally, various other modifications to such an audio security protocol 300 can be made in accordance with the present invention.

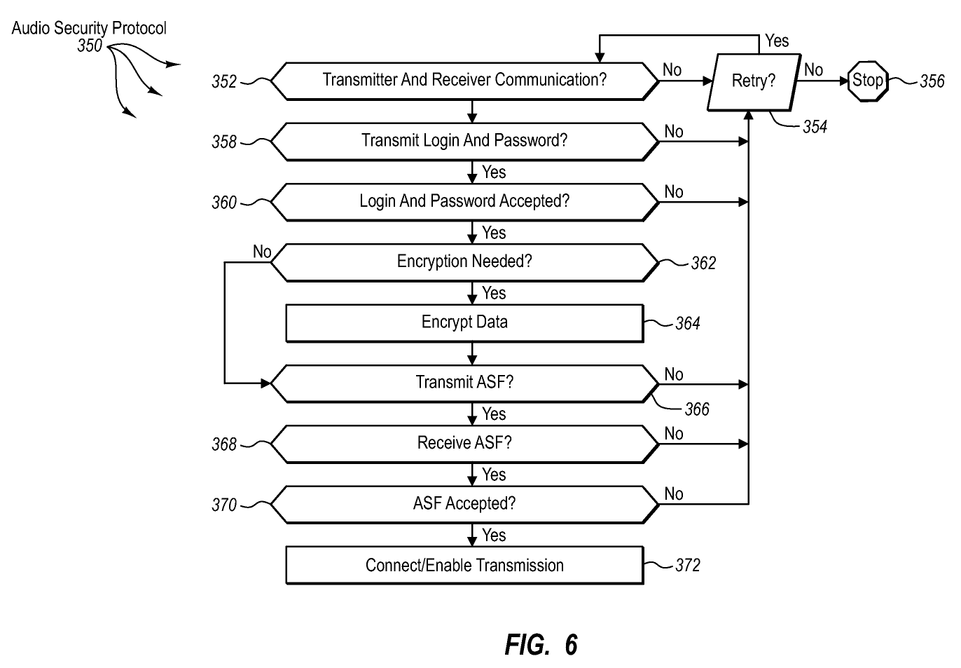

Referring now to FIG. 6, which is a flow diagram depicting an embodiment of an audio security protocol 350 in accordance with the present invention. In such an audio security protocol 350, a sender has selected an audio security feature to be played at the receiver. After such an audio security feature has been selected, the transmitter attempts to communicate with the receiver at 352. When the transmitter and receiver are not in communication, the transmitter can initiate a retry sequence at 354. The retry sequence includes another determination as to whether or not the transmitter and receiver are in communication at 352. This retry process at 354 can be continued until communication is established between the transmitter and receiver. On the other hand, when initiation of the retry sequence is denied, the transmitter can stop attempting to establish any communication with the receiver and terminate the audio security protocol 350 at 356.

In the instance it is determined that the transmitter and receiver are in communication at 352, the transmitter can then transmit a login and associated password to the receiver at 358. Accordingly, the login and password can be any of the various well known types of logins and/or passwords commonly used in order to gain access into a secured portal. If the transmitter does not transmit the login and password to the receiver, a retry sequence can again be attempted at 354. On the other hand, transmission of the login and password to the receiver can cause the receiver and/or any associated computer system to determine whether or not the login and password are acceptable at 360. As such, the receiver can process the login and password in a manner that compares the login and password to acceptable logins and passwords. Acceptable logins and passwords at 360 may be needed in order to continue with the audio security protocol. An unacceptable login and/or password can initiate another retry sequence at 354.

After the login and password are accepted, a determination can be made as to whether or not data encryption is required at 362. When encryption is needed, then such data requiring encryption can be encrypted or an encryption algorithm can be enabled at 364 before continuing to a transmission sequence. However, when encryption is not needed, the audio security protocol 350 can proceed directly to a transmission sequence.

The transmission sequence proceeds by transmitting the audio security feature to the receiver at 366. When the audio security feature is not transmitted to the receiver, the audio security protocol 350 can move to a retry sequence at 354. On the other hand, the transmission of the audio security feature can cause the receiver or associated computer system to determine whether or not the audio security feature has been received at 368. When the audio security feature has not been received into the receiver, another retry sequence can be initiated at 354. Receiving the audio security feature can then allow the audio security protocol 350 to continue.

In the instance the audio security feature is received, a determination can be made as to whether or not the audio security feature is acceptable at 370. The audio security feature can be determined to be acceptable by being processed through various algorithms, such as audio recognition logic, or by simply playing an audible audio security feature so that it can be heard by a person or other security manager. An unacceptable audio security feature can initiate another retry sequence at 354. On the other hand, an acceptable audio security feature can then connect the transmitter and receiver so as to enable data transmission therebetween at 372. Accordingly, this may enable the transmitter or sender of the transmission to gain access into a secured access port at the receiver so that access to a SAN, LAN, or other equipment associated with the receiver.

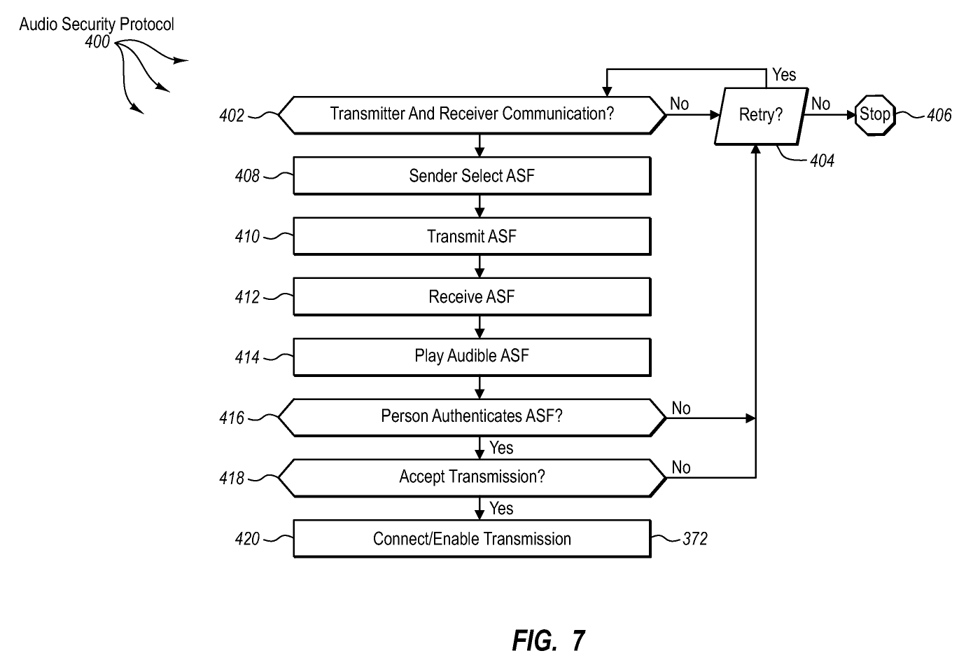

Referring now to FIG. 7, which is a flow diagram illustrating an embodiment of an audio security protocol 400 in accordance with the present invention. The initiation of such an audio security protocol 400 can begin with a determination as to whether or not the transmitter and receiver are in communication at 402. When the transmitter and receiver are not in communication, a retry sequence can be initiated at 404. The initiation of a retry sequence can result in another assessment as to whether or not the transmitter and receiver are in communication at 402. Alternatively, when the retry sequence is denied, then the audio security protocol 400 can stop at 406.

In the instance it is determined that the transmitter and receiver are in communication, the sender associated with the transmitter can then select an audio security feature to be sent to the receiver at 408. After being selected, the audio security feature can then be transmitted to the receiver at 410. As such, the receiver can then receive the other security feature at 412. The audio security feature is then audibly played over speakers at 414.

By being audibly played over speakers, any person, security manager, or entity associated with the receiver can then identify and/or authenticate the audio security feature at 416. In the event that the person does not authenticate the audio security feature, another retry sequence can be initiated 404. On the other hand, an authenticated or accepted audio security feature can result in a determination as to whether or not any data transmission between the transmitter and receiver can be accepted at 418. When the transmission is not accepted, another retry sequence can be initiated at 404. However, acceptance of the transmission can connect the transmitter and receiver so as to enable data transmission therebetween at 420.

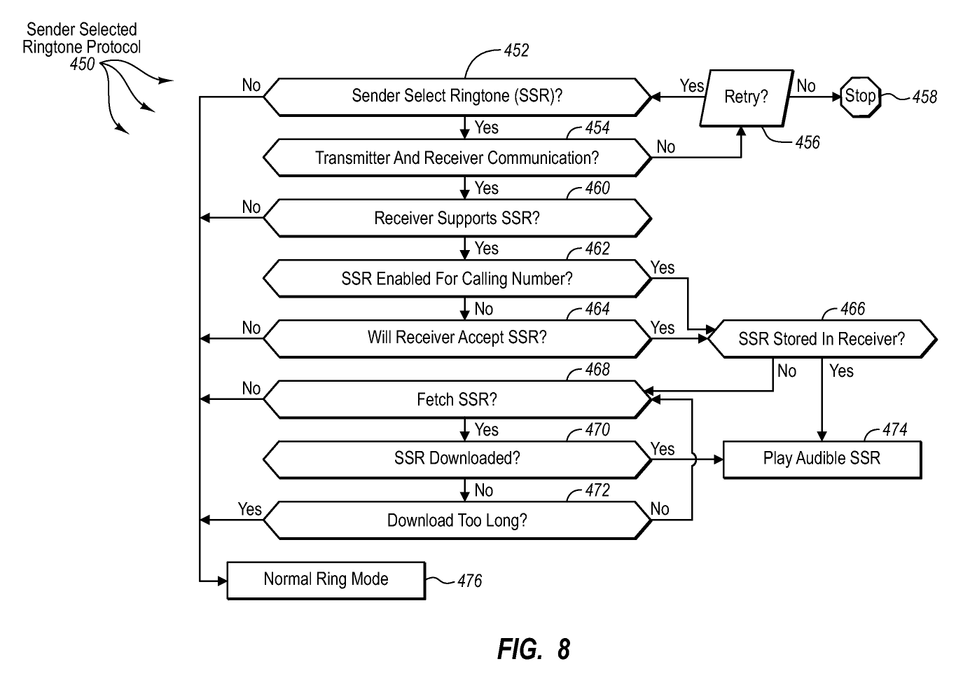

Referring now to FIG. 8, which is a flow diagram illustrating an embodiment of a sender-selected ringtone protocol 450 in accordance with the present invention, initiation of such a sender-selected ringtone protocol 450 can include the sender selecting a sender-selected ringtone (“SSR”) at 452. In the event the sender does not select a ringtone, a normal ring mode can be initiated at 476. On the other hand, when the sender does select a sender-selected ringtone, the transmitter can then initiate communication with the receiver at 454.

Accordingly, a determination can be made as to whether or not the transmitter and receiver are in communication at 454. When the transmitter and receiver are not in communication, a retry sequence can be initiated at 456. For a retry sequence to be initiated, the sender would then select the same sender-selected ringtone or another sender-selected ringtone at 452. On the other hand, when a retry sequence is denied, the sender-selected ringtone protocol 450 can be terminated and stopped at 458.

In the instance the transmitter and receiver are in communication, a determination can be made as to whether or not the receiver supports sender-selected ringtones at 460. When the receiver does not support sender-selected ringtone, the normal ring mode can be initiated at 476. However, a receiver that accepts sender-selected ringtones can result in a determination as to whether or not sender-selected ringtones are enabled for the transmitter (e.g. calling phone, calling number, etc.) at 462. For example, the receiver can match the telephone number of the transmitter with telephone numbers that have been identified as being pre-approved to allow the sender to select the ringtone to be played on the receiver (e.g. receiving mobile or land phone).

In one embodiment, when sender-selected ringtone are not enabled for the calling number, a determination can be made as to whether or not the receiver will or will not accept sender-selected ringtones from the calling number at 464. In the event sender-selected ringtones are or will not be accepted from the transmitter or calling number, the normal ring mode 476 is initiated. On the other hand, acceptance of sender-selected ringtones from the transmitter or calling number can result in a determination as to whether or not the sender-selected ringtone is stored in the receiver at 466.

In another embodiment, when sender-selected ringtones are enabled for the transmitter or calling number, the sender-selected ringtone protocol can likewise continue with the determination as to whether or not the sender-selected ringtone is stored in the receiver at 466. Having the sender-selected ringtone stored in the receiver can result in the receiver playing the sender-selected ringtone in an audible manner so as to be heard by the recipient of the call. Thus, the recipient of the call can identify the caller or sender by the audible sender-selected ringtone.

In the instance the sender-selected ringtone is not stored in the receiver, a determination can be made as to whether or not to fetch the sender-selected ringtone at 468. For example, the sender-selected ringtone can be fetched from either the transmitter, which is most likely a mobile phone, or from a ringtone server or other similar ringtone system at 468. On the other hand, the normal ring mode (at 476) can be initiated when no attempt to fetch the ringtone is made.

After a fetch sequence is initiated, such as from the transmitter or ringtone server, the sender-selected ringtone can then be transmitted and/or otherwise downloaded into the receiver at 470. During the download, a determination can be made as to whether or not the sender-selected ringtone has been successfully downloaded at 470. When the sender-selected ringtone has not been downloaded, a determination can be made as to whether or not the download may take too long at 472. Downloads that take too long can be unfavorable in some instances, which can result in an initiation of the normal ring mode at 476. On the other hand, a download that will not take too long can continue to be fetched at 468, wherein the following sequence can again be performed.

In any event, after the sender-selected ringtone is downloaded, the sender-selected ringtone can be played at the receiver as an audible audio file or sound. The ringtone can be any type of sound such as music, animal noises, poems, greetings from the sender, and the like. Accordingly, the sender-selected ringtone can notify the receiver of the identification of the sender.

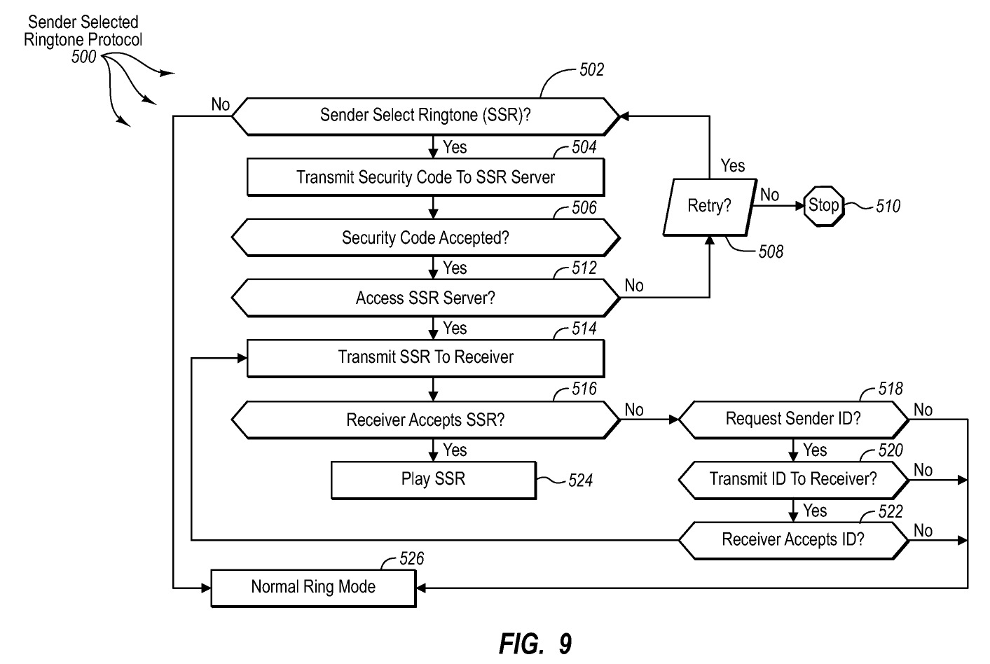

Referring now to FIG. 9, which is a flow diagram illustrating an embodiment of a sender-selected ringtone protocol 500. Such a sender-selected ringtone protocol 500 includes a sender selecting a ringtone at 502. In the event the sender does not select a ringtone, a normal ring mode is initiated at 526. However, when the sender does select the ringtone at 502, the transmitter then transmits a security code to a sender-selected ringtone server (“SSR server”) 504.

After the security code is received by the sender-selected ringtone server, a determination is made as to whether or not the security code is acceptable or authenticated in order to allow the sender to gain access into the sender-select ringtone server at 506. When the security code is not accepted at 506, a retry sequence is initiated at 508. The initiation of the retry sequence returns the sender-selected ringtone protocol 500 to the sender selecting a ringtone at 502. On the other hand, when the retry sequence is denied at 508, the sender-selected ringtone protocol 500 is terminated and/or stopped at 510.

In the instance the security code is accepted by the sender-selected ringtone server at 506, a determination is made as to whether or not access thereto is enabled for the sender at 512. When access to the sender-selected ringtone server is denied or not enabled, the retry sequence can be initiated at 508. While the security code may have been accepted, there may be certain reasons why access into the sender-selected ringtone server may be denied. In any event, after granting or enabling access to the sender-selected ringtone server, the server is instructed to transmit the sender-selected ringtone to the receiver at 514.

Accordingly, a determination is made as to whether or not the receiver will accept the sender-selected ringtone at 516. When the receiver does not accept the sender-selected ringtone, a request can be sent to the transmitter for the sender to submit identification at 518. If no request for the sender to submit identification is made, the normal ring mode is initiated at 526. Alternatively, when the request is made for the sender to submit the identification, the transmitter and/or sender-selected ringtone server can transmit the sender identification to the receiver at 520. In some instances, no transmission of sender identification is made, and the normal ring mode is initiated at 526.

In the instance the sender identification is sent to the receiver, a determination is made as to whether or not the receiver accepts the sender identification at 522. When the receiver does not accept the sender identification, the normal ring mode is initiated at 526. On the other hand, when the receiver does accept the sender identification, the receiver can then instruct and/or allow the sender and/or ringtone server to transmit the sender-selected ringtone to the receiver at 514. Accordingly, the receiver can then determine whether or not to accept this sender-selected ringtone at 516.

In any event, whenever the receiver does accept the sender-selected ringtone, even after the initial sender-selected ringtone may have been rejected, such acceptance of the sender-selected ringtone can cause the sender-selected ringtone to be played as an audible ringtone at the receiver or receiving handset (e.g. mobile or landline phone). Thus, a proper security code (e.g. identification, caller ID) coupled with the sender-selected ringtone can result in the receiver or target recipient being notified of the identity of the sender.

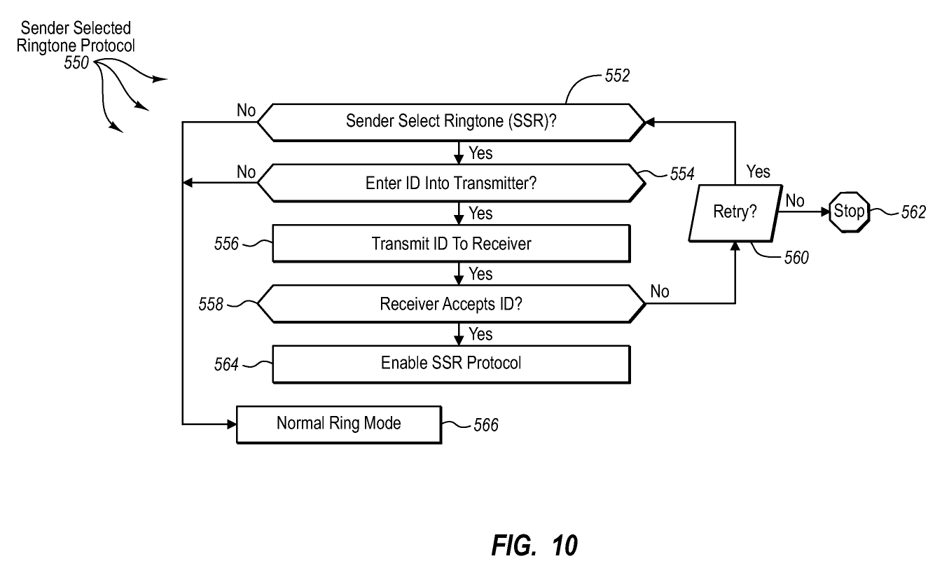

Referring now to FIG. 10, which is a flow diagram illustrating an embodiment of a sender-selected ringtone protocol 550 in accordance with the present invention. Such a sender-selected ringtone protocol 550 includes the sender selecting a ringtone at 552; however, if the sender does not select a ringtone, the normal ring mode is initiated at 556. In the event the sender does select a ringtone, the sender can then enter an identification number (“ID”) or other identification code into the transmitter at 554. When the sender does not enter such ID or identification code, the normal ring mode is initiated at 556. On the other hand, when the sender does enter the ID or identification code into the transmitter, the ID or identification code is then transmitted to the receiver at 556.

Accordingly, after being received into the receiver, a determination is made as to whether or not the ID or identification code is acceptable at 558. If the receiver does not accept the ID or identification code, a retry sequence can be initiated at 560. When the retry sequence is initiated, the sender can then select the same ringtone or another ringtone at 552. However, if the retry is denied at 560, the sender-selected ringtone protocol 550 can be terminated or stopped at 562.

In the instance the receiver does accept the ID or identification code, the receiver can then enable the sender-selected ringtone protocol at 564. This can result in the operation of various protocols described herein for the purpose of playing the sender-selected ringtone on the receiver handset (e.g. mobile or landline phone).

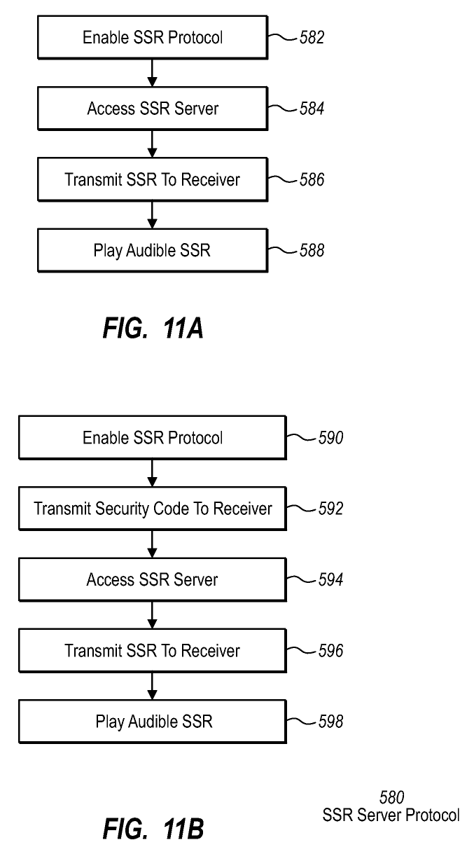

Referring now to FIG. 11A, which is a flow diagram of a sender-selected ringtone server protocol 580. Accordingly, the sender-selected ringtone protocol can be enabled at 582, which can be the protocol depicted and described in connection with FIG. 10. After the sender-selected ringtone protocol is enabled, access to a sender-selected ringtone server can be allowed at 584. This can lead to the sender-selected ringtone server sending the selected ringtone to the receiver at 586. Accordingly, the receiver can then play the audible sender-selected ringtone at 588. Thus, the audible sound of the ringtone can notify the receiver of the identity of the sender.

Another embodiment of a sender-selected ringtone server protocol 580 is depicted in FIG. 11B. Such a sender-selected ringtone protocol can be enabled at 590, which can be the protocol depicted and described in connection with FIG. 10. After enabling the sender-selected ringtone protocol, the transmitter can then transmit a security code to the receiver at 592. This security code can then allow the receiver to access the sender-selected ringtone server at 594. Accordingly, the sender-selected ringtone can then proceed with transmitting the sender-selected ringtone to the receiver at 596. As such, the receiver can then play the audible sender-selected ringtone at 598.

Thus, various embodiments of enabling access into a sender-selected ringtone server by a transmitter and/or receiver can allow for the sender-selected ringtone to notify the receiver of the identity of the sender.

In one embodiment of the present invention, the foregoing methods and protocols, or portions thereof, can be performed by a computing system. Such a computing system can utilize a computer program product that implements the foregoing methods and protocols. The computer program product includes one or more computer readable media having stored thereon computer-executable instructions that when executed by a processor within any of the computer systems, mobile phones, landline phones, or other communication or computing device, cause such device to perform the methods and protocols of the invention described herein for allowing a sender to select an audio-identification clip, audio security feature, and/or ringtone to be played at a receiver.

In one embodiment, the sender-selected ringtones can include tags. Such tags can be used to notify the receiver about the nature of the ringtone. Such as, for example, any explicit or questionable sounds. These tags can be reviewed by the target recipient on a display, or can be predetermined by the receiving device. This can allow for a means of rating the ringtones so that undesirable sounds are not played over the receiving device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for using an audio feature to authenticate access to a secured network, the system comprising:
a sending device configured to communicate with a receiving device over at least one network;
an audio feature, wherein the audio feature is selected by the sending device, and wherein the audio feature identifies the sending device to the receiving device; and
a security manager, wherein the security manager is configured to function with the receiving device and a secured network, wherein the security manager processes the audio feature such that at least one of a person or audio recognition logic determines whether the sending device is authorized to remotely access the secured network.

2. The system of claim 1, wherein the audio feature is embedded in an audio file, the audio file being configured to be played such that it is audible a person, wherein the audio feature is inaudible to a person.

3. The system of claim 1, further comprising a server that stores the audio feature, wherein the sending device accesses the server to select the audio feature that is delivered to the security manager.

4. The system of claim 1, wherein the security manager processes the audio feature by playing the audio feature when the person determines whether the sending device is authorized.

5. The system of claim 3, wherein the sending device communicates with the server over the network and wherein the server stores a plurality of audio features from which the sending device selects the audio feature.

6. The system of claim 1, wherein at least one of the sending device and the receiving device comprises a mobile phone.

7. The system of claim 3, wherein the sending device accesses the server and wherein the server transmits the audio feature to the receiving device.

8. The system of claim 1, wherein the security manage compares the audio feature to a reference audio feature to authenticate the sending device.

9. The system of claim 1, wherein the audio recognition logic monitors the audio feature and compares the audio feature to authorized data, wherein the security manager connects the sending device with the receiving device if the audio feature is recognized and authorized.

10. The system of claim 1, wherein at least one of:
the audio feature comprises an audio recognition feature that is selected by the sending device and that identifies the sending device to the receiving device;
the audio feature comprises an audio security feature that is selected by the sending device and that authenticates the sending device to the receiving device; or
the audio feature comprises a sender selected ringtone that identifies the sending device to a recipient.

11. A method for using an audio security feature to authenticate access into a secured network, the method comprising:
selecting an audio security feature, at a sending device, to be processed at a security manager for a secured network;
sending the audio security feature from the sending device to the security manager over a network; and
processing the audio security feature at the security manager in a manner so as to enable at least one of a person or audio recognition logic to determine whether the remote computer is authorized to remotely access the secured network.

12. The method of claim 11, wherein the selecting an audio security feature includes:
accessing a server, wherein the server stores a plurality of audio security features; and
selecting, by the sending device, the audio security feature from the plurality of audio security features.

13. The method of claim 12, wherein the audio security feature selected by the sending device is selected based on an identity of a receiving device and wherein the sending device comprises one of mobile phone, a personal computer or a wireless device.

14. The method of claim 11, wherein sending the audio security feature from the sending device to the security manager further comprises:
storing the audio security feature at a server; and
transmitting the audio security feature to the security manager after the audio security feature is selected by the sending device.

15. The method of claim 14, further comprising the server receiving the audio security feature from the sending device.

16. The method of claim 11, wherein the audio security feature comprises a ringtone and processing the audio security feature at the security manager comprises playing the ringtone for a recipient such that a sender is recognized by the recipient.

17. The method of claim 11, wherein processing the audio security feature at the security manager further comprises at least one of:
playing at least a portion of the audio security feature to the person; and
comparing, by the audio recognition logic, the audio security feature to authorized audio security features.

18. The method of claim 11, wherein the selecting an audio security feature is performed by a sender, wherein the sender selects the audio security feature to identify the sender to the server security manager.

19. A method for a sender to select and send a ringtone to a recipient, the method comprising:
selecting a ringtone, by a sender using a sending communication device, wherein the ringtone is configured to be audibly played on a receiving communication device;
sending the ringtone to the receiving communication device, wherein the receiving communication device is configured to audibly play the ringtone; and
playing the selected ringtone on a speaker of the receiving communication device, wherein the ringtone is associated with an identity of the sender.

20. The method of claim 19, further comprising, sending data from the sending communication device to a ringtone server that instructs the ringtone server to identify the selected ringtone and transmit the selected ringtone to the receiving communication device.

21. The method of claim 20, wherein the ringtone is stored on the ringtone server and wherein the sending the ringtone is performed by the ringtone server.

22. The method of claim 19, further comprising:
receiving the ringtone on the receiving communication device;
identifying the data associated with a security protocol;
determining the validity of the data associated with a security protocol; and
allowing access, based on the validity of the data, by the sending communication device to secured information accessible through the receiving communication device.

23. The method of claim 19, wherein selecting a ringtone further comprises accessing a server, wherein the server stores a plurality of ringtones and wherein at least some of the ringtones have been authorized.

24. The method of claim 23, wherein selecting a ringtone further comprises:
the server receiving the ringtone from the sending communication device; and
transmitting the ringtone to the receiving communication device if the receiving communication devices accepts the ringtone.
